(19) United States
(12) Patent Application Publication
(10) Pub. No.: US 2004/0096160 A1
(43) Pub. Date: May 20, 2004

(54) Device for multiplying light frequencies

(76) Inventors: Iliyana Hinkov, Kirchzarten (DE); Vladimir Hinkov, Kirchzarten (DE)

Correspondence Address: Law Offices of Karl Hormann, PO Box 381516, Cambridge, MA, 02238-1516, US

(21) Appl. No.: 10/466,912

(22) PCT Filed: Jan. 18, 2002
(86) PCT No.: PCT/EP02/00466

(30) Foreign Application Priority Data
Jan. 22, 2001 (DE) 101 02 683.8

(51) Int. Cl. G02B 6/26; G02F 2/02

(52) U.S. Cl. 385/40; 359/328

(57) ABSTRACT

The invention relates to a device for multiplying light frequencies, especially laser light. Said device comprises an optically non-linear element having a rigid structure with normal regions and inversion regions, the direction of the spontaneous polarization in the inversion regions being inverted in relation to the normal direction in the normal regions. The inventive device also comprises electrodes for producing an electric field. The aim of the invention is to create a device which enables light frequencies to be multiplied and a higher conversion efficiency of a coupled pumping wave in relation to known devices. To this end, the grid structure consists of at least one first grid section (21; 41; 65), the electrodes (29, 30; 51, 52; 54, 55; 58, 59, 60; 72, 73) being associated with the second grid section (22; 42; 66).

The invention relates to a device for multiplying frequencies of light, more particularly of laser light, with an optical non-linear element provided with a grid structure of normal regions and inversion regions, whereby in the inversion regions the direction of the spontaneous polarization is inverted relative to a normal direction in the normal regions, and with electrodes for generating an electric field.

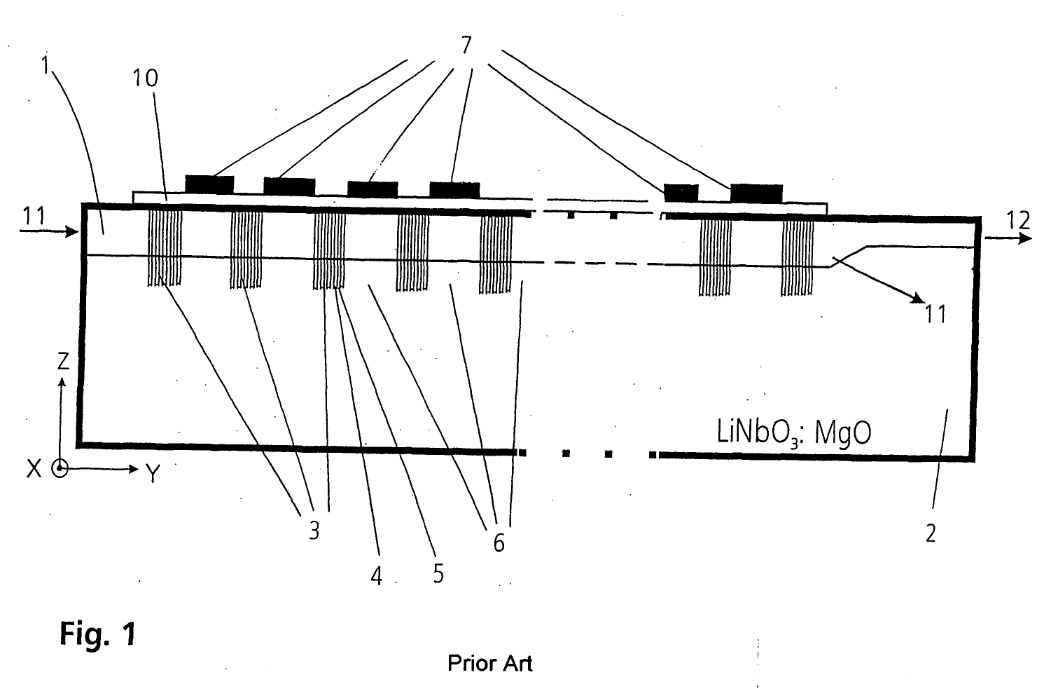

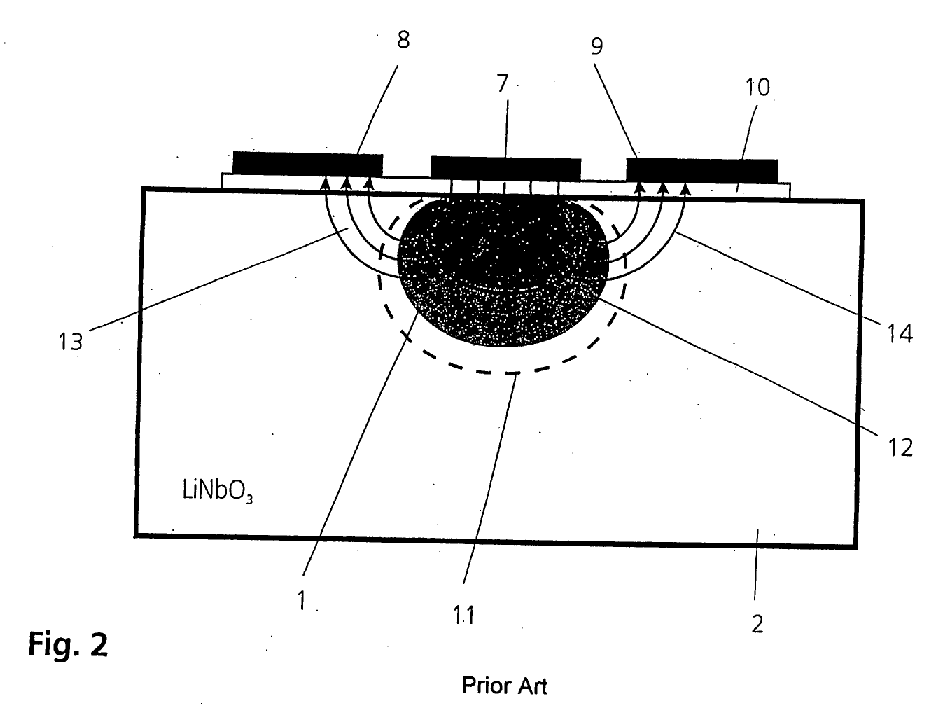

Such a device is known from German Patent DE 195 14 823 C1. In that device, the grid structure is constructed of at least two spaced grid sections between which control sections are disposed, with the electrodes being arranged within the control sections (FIGS. 1 and 2).

By dividing the grid structure into grid sections and by positioning, between the grid sections, control sections which may be affected by an electric voltage, it is intended to equalize the relative phase shift as it may arise, for instance, from deviations in manufacturing parameters, between the coupled-in pumping wave and the generated harmonic wave.

The object of the invention resides in providing a device of the kind referred to by which, relative to known devices, light frequencies may be multiplied at an even greater degree of conversion efficiency of a coupled-in pumping wave.

In accordance with the invention, the object is accomplished by the grid structure being made up of at least one first grid section and one second grid section directly abutting the first grid section and by electrodes associated with the second grid section.

In an advantageous embodiment, the second grid section has a grid period differing from the grid period of the first grid section.

In a further preferred embodiment, at least one first and one abutting second grid section form a grid region, and several grid regions are aligned in a linear array. In a particularly advantageous embodiment, the grid periods of the first and/or of the second grid sections differ from grid region to grid region.

Another advantageous embodiment consists of the optically non-linear element being fabricated from a planar ferro-electric crystal, more particularly from a LiNbO₃ or LiTaO₃ crystal.

In a further advantageous embodiment, the grid structure completely permeates the planar crystal from its upper surface to its lower surface.

A further advantageous embodiment provides for the grid structure extending from a front surface to the opposite front surface of the crystal.

In a further advantageous embodiment, the crystal is provided with an optical wave guide extending between two front surfaces of the planar crystal along the upper surface thereof and thereby traversing the grid sections.

Further useful embodiments of the invention are the subject matter of further subclaims.

The invention will hereinafter be described in greater detail with reference to embodiments and an appurtenant drawing, in which:

FIG. 1 is a view in longitudinal section of a device for multiplying light frequencies with a wave guide and a grid structure constructed of grid sections and interposed control sections in accordance with the prior art;

FIG. 2 is a cross-sectional view of the device of FIG. 1 in the area of a control section;

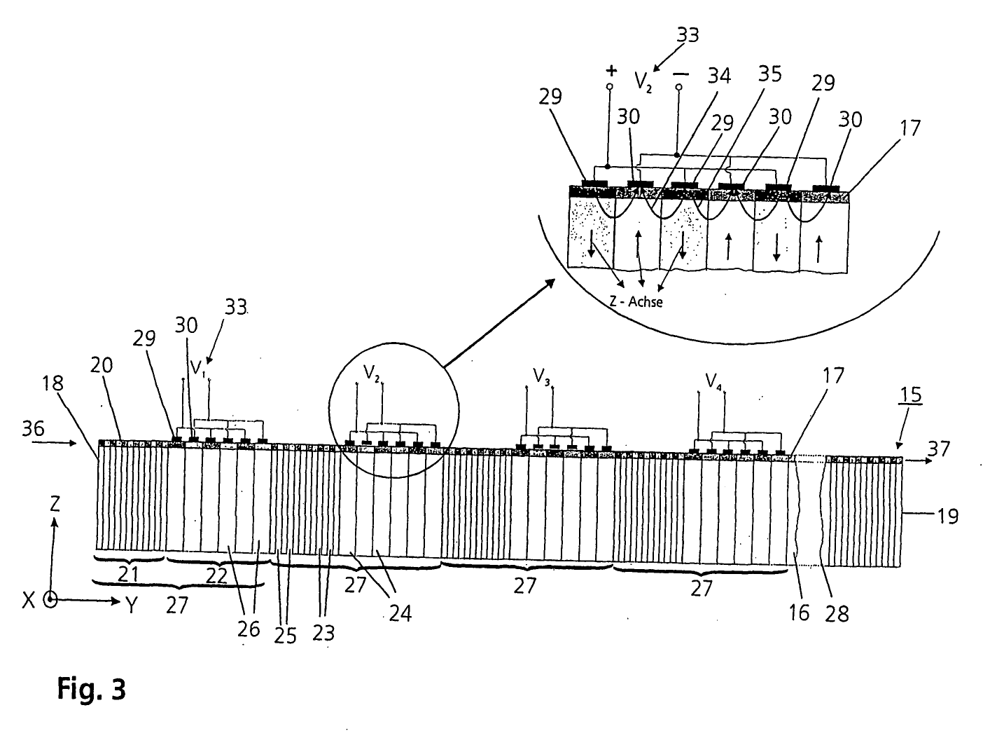

FIG. 3 is a view in longitudinal section of a first device in accordance with the invention for multiplying light frequencies;

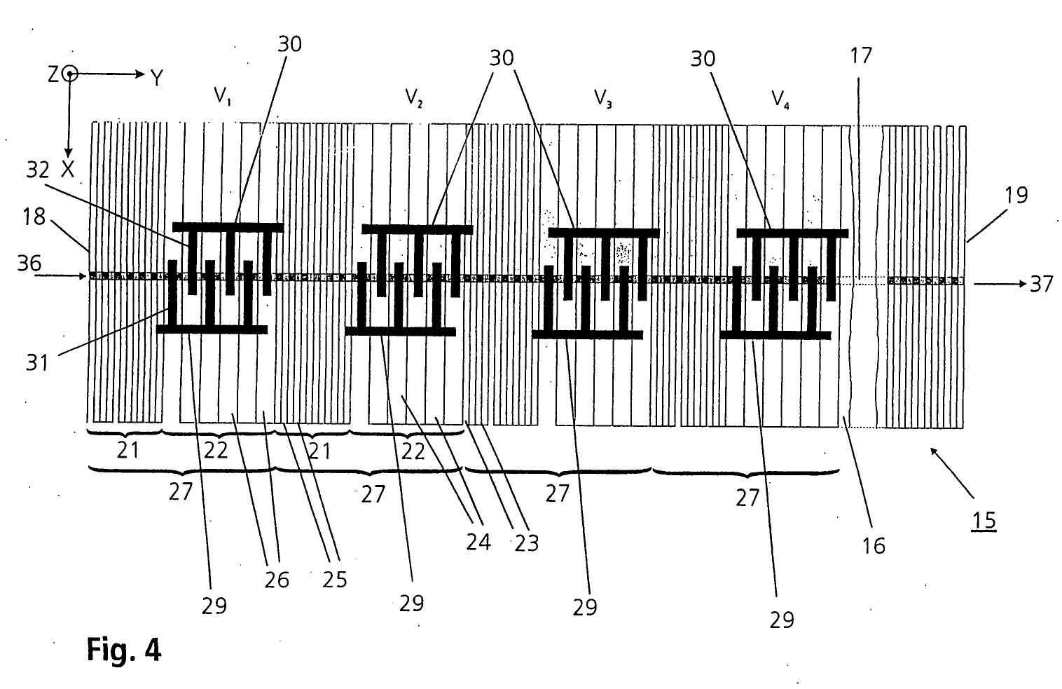

FIG. 4 is a top elevational view of the device of FIG. 3;

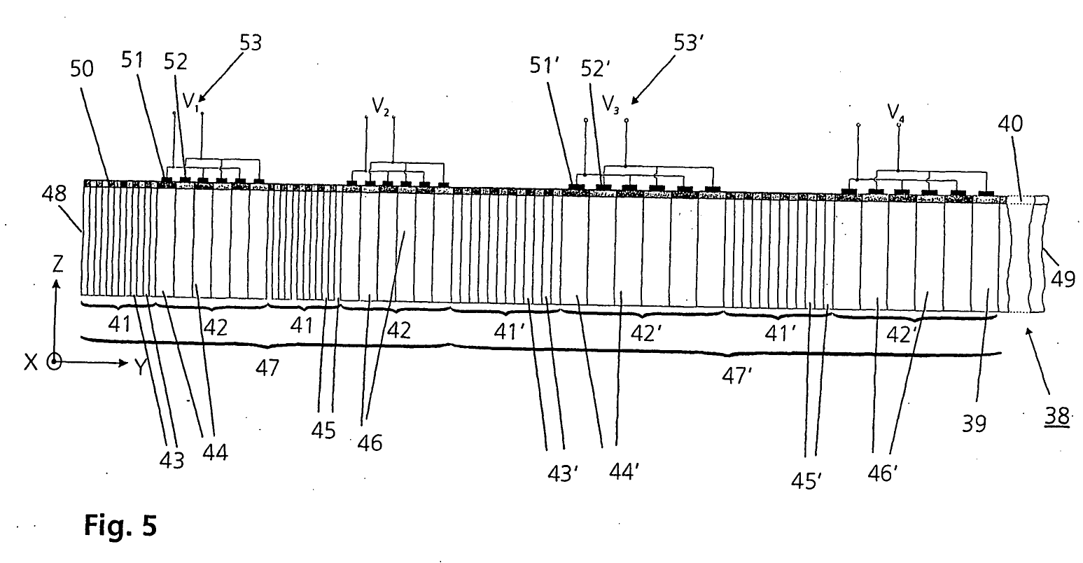

FIG. 5 is a view in longitudinal section of a second device in accordance with the invention for multiplying light frequencies;

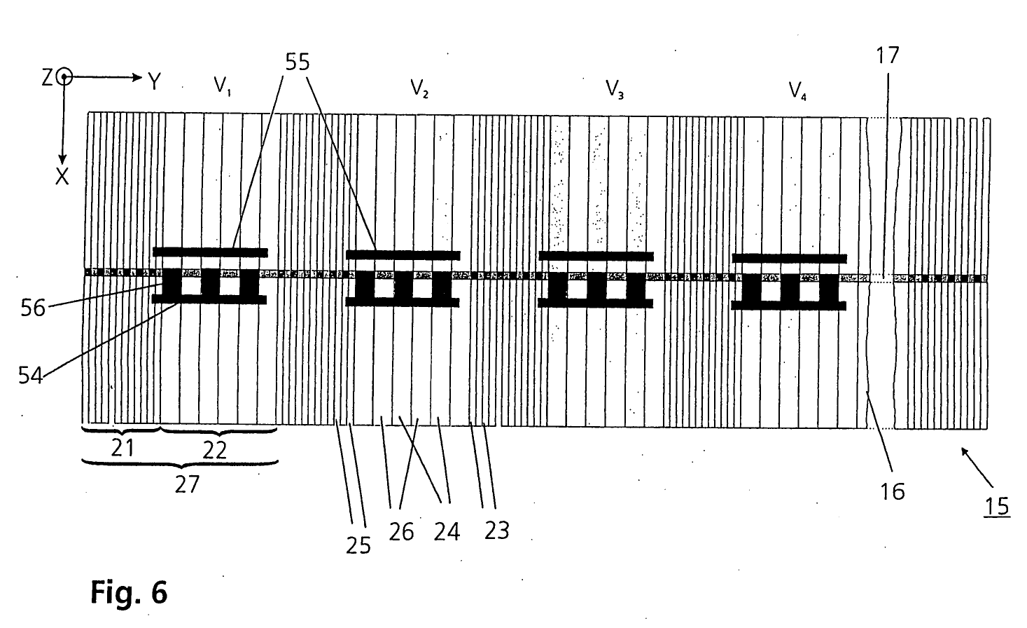

FIG. 6 depicts a device in accordance with the invention for multiplying light frequencies with electrodes of a first changed shape and arrangement from those of FIGS. 3 and 4;

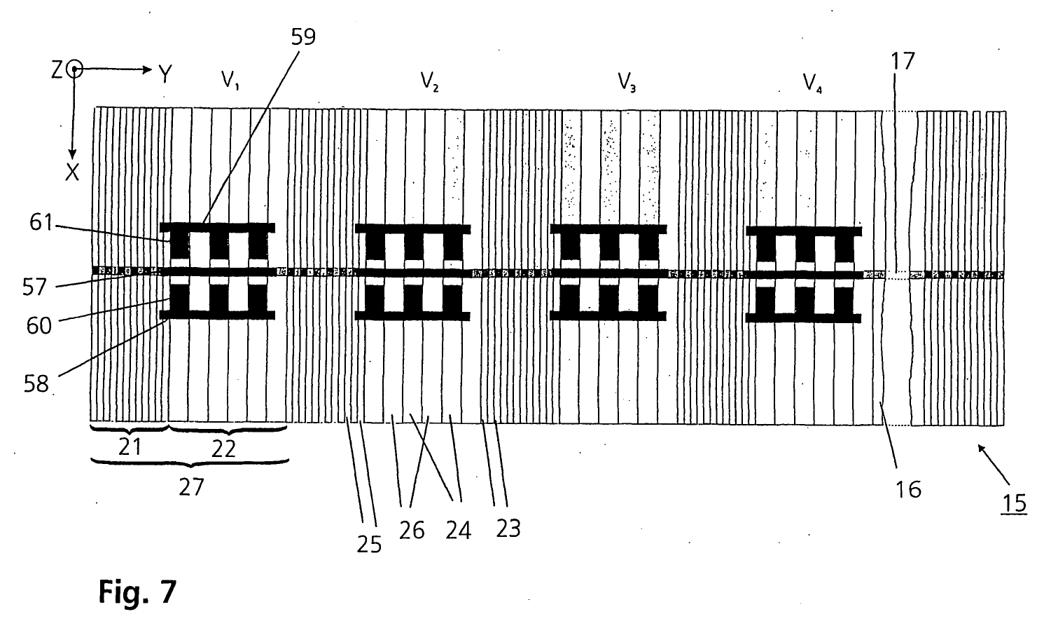

FIG. 7 depicts a device in accordance with the invention for multiplying light frequencies with electrodes of a second changed shape and arrangement from those of FIGS. 3 and 4;

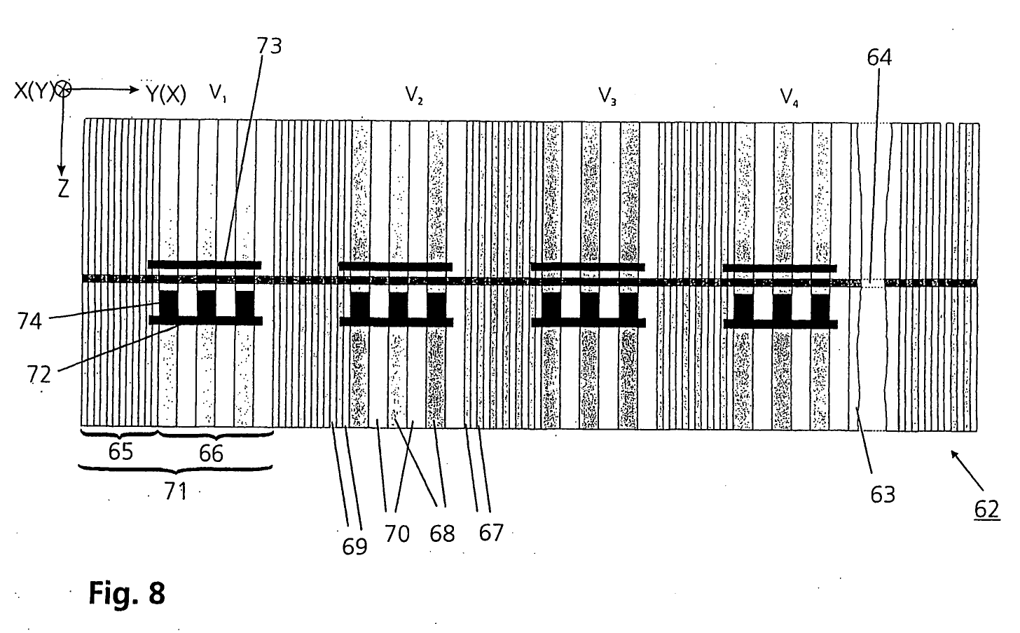

FIG. 8 depicts a third device in accordance with the invention for multiplying light frequencies.

The conventional device for multiplying light frequencies shown in FIGS. 1 and 2 is provided with a wave guide 1 inserted into a substrate 2 in a well-known manner. The substrate 2 is a ferro-electrical crystal, for instance LiNbO₃ or LiTaO₃. In the example shown, the crystal is prepared in the z-section relative to the x, y plane, and the wave guide 1 extends in the y direction, from one end of the crystal to the other. The wave guide 1 traverses a grid structure consisting of grid sections 3 for the so-called quasi phase synchronization (QPS) of a pumping wave coupled into the wave guide 1 and a generated harmonic wave of twice the frequency. The grid sections each consist of inversion regions 4 and normal regions 5, with the direction of the optical z-axes in the normal regions 5 being aligned in a normal direction parallel to the z-axes of the wave guide 1 and the substrate 2, whereas in the inversion regions 4 the direction of the z-axes is inverted by 180° relative to the normal direction. Between the grid sections 3, and directly abutting therewith, there are provided control sections 6 of a length corresponding to a multiple of the grid period of the grid sections 3 and in each one of which, in the area of the wave guide 1, there are arranged a center electrode 7 and outer electrodes 8, 9.

By applying a voltage between the center electrode and the outer electrodes 8, 9, the control sections 6, which in this example are interposed between the grid sections 3, it is possible to tune the spectral acceptance range of the grid structure made up of the grid sections 3 to the frequency of the pumping wave. The pumping wave may be generated, for instance, by a semiconductor laser and be coupled into the wave guide 1 by a coupling lens. As a result of the applied voltage and the electric field generated thereby in the crystal between the center electrode 7 and the outer electrodes 8, 9, the effective indices of refraction are changed differently for the pumping wave on the one hand and for the harmonic wave on the other hand. The relative phase between the pumping wave and the harmonic wave may thus be controlled as a function of the applied voltage and be tuned to the conditions of phase matching prior to entering the following grid section 3. It is thus possible to attain a tuning range of several nanometers, so that for purposes of maintaining the degree of conversion efficiency, deviations in the frequency of the pumping wave may in some way be equalized over this range. From FIG. 2 it may, furthermore, be seen that an optical insulation layer 10 is disposed between the electrodes 7, 8, 9 and the substrate 2. The insulation layer 10 serves to avoid light absorption by the electrodes 7, 8, 9.

Moreover, FIG. 2 shows the electric fields of a pumping wave 11 and of a harmonic wave 12 of double frequency propagating within the wave guide 1, as well as several electric field lines 13, 14 between the center electrode 7 and the outer electrodes 8, 9. It can be see that as a result of the different depths of penetration of the pumping wave 11 and of the harmonic wave 12 into the wave guide 1 or substrate 2 from the upper surface facing the electrodes 7, 8, 9, the effective overlap of the harmonic wave 12 with the electric field in the area of high field intensity is much greater than of the pumping wave 11, so that it also experiences much higher changes in the index of refraction.

The known device suffers from the following disadvantages, however: The control sections 6 have no periodic domain structure and thus do not directly contribute to generating a harmonic wave (SHG wave). Thus, the generated intensity of the SHG wave is smaller than would in principle be possible by utilization of the entire length of the wave guide. Moreover, the lacking domain structure, i.e. the lack of a grid structure in these control sections 5, reduced the resistance of the optical wave guide against optical damage. This, in turn, may adversely affect the stability of the SHG wave. Simultaneous generation of differing wavelengths is impossible in the known device. Moreover, the entire QPS structure does not extend to the ends of the crystal platelet which results in loss of the interactive length and in a reduced resistance against optical damage within these regions.

These disadvantages are avoided by the devices in accordance with the invention to be described hereinafter.

FIG. 3 depicts in longitudinal section a first device 15 in accordance with the invention for multiplying light frequencies. Here, too, the substrate is a ferro-electric crystal 16, e.g. of LiNbO₃ or LiTaO₃. The plate-shaped ferro-electric crystal 16 is cut in the z direction and is provided with an optical wave guide 17 which extends in the y direction of the x, y plane, along the upper surface 20 of the crystal 16, between end surfaces 18, 19. The wave guide 17 traverses a grid structure formed by first and second grid sections 21 and 22, each consisting of an inversion region 23 and 24 and normal regions 25 and 26. In the normal regions 25, 26 the direction of the optical z-axis is aligned in a normal direction, parallel to the z-axes of the wave guide 17 and of the crystal 16; in the inversion regions 23, 24, however, the direction of the z-axes is inverted relative to the normal direction.

In the examples shown in FIGS. 3 and 4, the first and the directly abutting second grid section 21 and 22 form a grid region 27, with several such grid regions 27 being disposed in a linear array. The grid structure extends completely from one front surface 18 to the other front surface 19 of the crystal 16 and completely permeates the crystal from its upper surface 20 to its lower surface 28. A pair of comb-shaped electrodes 29, 30 disposed on the upper surface 20 of the crystal 26 is associated with every other grid section 22. One of the electrodes of the pair of electrodes is placed such that its electrode fingers 31 extend in the x-direction along the normal regions 26. The length of the electrode fingers 31 and 32 of the two electrodes 29, 30 is such that they extend interdigitally over the width of the wave guide 17. The width of each electrode finger 31 and 32 is narrower than the extension of each normal region 26 and each inversion region 24 in the y-direction. In the direction of the grid lines, the electrode fingers 31, 32 preferably are each centrally arranged on the inversion and normal regions 24, 26. The electrodes 29, 30 may be fabricated of thin layers of metal or of an optically transparent electrically conductive material, e.g. ITO. In the former case, an optically insulating layer, for instance of SiO₃ (not shown in the drawings), must be provided between the electrodes 29, 30 and the upper surface 20 of the crystal 16, in order to prevent light absorption by the metal layer.

Each of the electrodes 29, 30 associated with the second grid sections 22 is connected to a voltage source 33. In the example of FIG. 3, the second grid section 22 has a grid period differing from the grid period of the first grid section 21. The two grid periods are selected such that a quasi phase synchronization (QPS) for the pumping wavelength of the laser is ensured in both grid sections 21, 22. For instance, it may be a first order QPS (m=1 in grid section 21) combined with a third order QPS (m=3 in grid section 22).

As shown in detail in FIG. 3, the electric field lines identified in the drawing as 34 and 35 extend, depending upon the polarization of the voltage applied to the electrodes 29, 30, such that in all regions of the second grid section 22, i.e. in the inversion regions 24 as well as in the normal regions 26, they are either of the same orientation as the z-axis or they are oriented in a direction opposite the z-axis. Accordingly, in all inversion and normal regions 24, 26 of the second and, therefore, controlled grid section 22, the electric field induces identical changes in the refractive index so that the individual phase contributions are added from grid line to grid line. Due to dispersion, the change in refractive index for the pumping wave 35 differs from that for the harmonic (SHG) wave 37, which is what makes their phase matching possible. In other words, by the level of the electric voltage V the phases of the interacting waves may be set such that the SHG wave is constructively further built up in the grid sections (QPS—first order regions). At the same time, the harmonic wave is amplified in the grid sections 22 because the third order QPS condition is satisfied there. In case the wave length of the pump laser is changed or if there is a fabrication-inherent inhomogeneity of the grid structure, a coherent addition of the contribution of the individual grid sections 21, 22 may be attained by a voltage V of a correspondingly changed level. The electrodes 29, 30 associated with the second grid sections 22 may either be energized by identical voltages V or by different voltages V₁ to Vₙ in correspondence with the number n of linearly arrayed grid sections 27. Thus, fluctuations in effective refractive indices of modes propagating in the wave guide 17 may be compensated by different voltages, which will also cause different phase changes.

Whereas several grid regions 27 are linearly arrayed in the embodiment of FIGS. 3 and 4, it is also conceivable, and it is within the ambit of the invention, to provide but a single one of such grid regions 27 which will have at least one grid section 21 without electrodes and one grid section 22 with associated electrodes 29, 30. In each case, the minimum length of each grid section 21 or 22 is one grid period. The only condition which must be satisfied by the grid structure in the individual grid sections 21, 22 is that its grid period provides quasi phase synchronization of a predetermined order for a pumping wave of given wavelength.

Hence, the grid period must be the same in grid sections 21 and grid sections 22 or, as shown in FIGS. 3 and 4 and subject to the mentioned condition, the grid period of the second grid sections 22 may deviate from the grid period of the first grid sections 21. If the inversion and normal regions 24 and 26 of the second grid sections 22 are wider in the direction of the wave guide or light propagation than the inversion and normal regions 23, 25 of the first grid sections 21, the resulting advantage is that the electrodes 29, 30 may be of larger dimension and can thus be fabricated more easily.

Another device 38 which is of interest because of its suitability for doubling or multiplying several wave lengths of a pump laser simultaneously, is shown in FIG. 5. In this case, the substrate is also a ferro-electric crystal 39 cut in the z-direction and provided with a wave guide 40. The wave guide 40 which extends in the xy-plane in the y direction, initially alternatingly traverses a grid structure made up of first grid sections 41 and second grid sections 42, each of the first grid sections 41 having a first grid period with inversion regions 43 and normal regions 45 and each of the second grid sections 42 having a second grid period with inversion regions 44 and normal regions 46. The two first and the two second grid sections 41 and 42 form a grid region 47. Directly abutting this grid region 47, the wave guide 40 traverses a grid region 47′ made up of alternating first grid sections 41′ and second grid sections 42′. The grid period of the first grid sections 41′ with their inversion regions 43′ and normal regions 45′ is as different from the grid period of the first grid section 41 of the grid region 47 as the grid period of the second grid sections 42′ with their inversion regions 44′ and normal regions 46′ is different from the second grid sections 42 of the grid region 47. The optical wave guide 40 which in the example of FIG. 5 extends along the upper surface 50 of the plate-shaped crystal 39 from one front surface 49 to the opposite front surface 49 must be structured to be capable of propagating light of the corresponding wave lengths.

The electro-optical control is here carried out by way of the electrodes 51, 52 or 51′, 52′ associated with the second grid sections 42 and 42′ and each respectively connected to voltage source 53 and 53′. The pairs of electrodes 51, 52 and 51′, 52′ may be of the same shape, and may be arranged in the same manner, as in the embodiment of FIGS. 3 and 4.

For crystals cut in the z-direction other shapes and arrangements of the electrodes associated with the second grid sections are also conceivable. FIGS. 6 and 7 depict two possible variants.

Thus, in the embodiment of FIG. 6 one electrode 54 of the pair of electrodes associated with the second grid section 22 is comb-shaped, the other electrode 55, in contrast, is strip-shaped. The comb-shaped electrode 54 is placed on the upper surface 20 of the crustal 16 such that its electrode fingers 56 extend in the x-direction along the inversion regions 24 and traverse the entire width of the wave guide 17. The strip-shaped electrode 55 is arranged on the upper surface 20 of the crystal 16, on the opposite side of the wave guide 17 spaced therefrom and parallel thereto. A further variant, not shown in the drawing, is provided with a pair of electrodes is associated with every second grid section 22, one electrode being comb-shaped and placed on the upper surface 20 of the crystal 16 such that its electrode fingers extend in the x-direction along the inversion regions 24 and terminate at a distance from the wave guide 17. The second electrode is strip-shaped and is arranged on the upper surface 20 of the crystal 16 extending longitudinally of the wave guide 17 and covering it.

In the variant according to FIG. 7 each second grid section 22 is associated with a center electrode 57 and two outer electrodes 58, 59. The center electrode 57 is strip-shaped and is arranged on the upper surface 20 of the crystal 16 in the center thereof and extending in the direction of, and covering, the wave guide 17. Both outer electrodes 58, 59 are comb-shaped and are placed on the upper surface 20 of the crystal 16 on opposite sides of the wave guide 17 such that their electrode fingers 60, 61 extend in the x-direction along the inversion regions and terminate at a distance from the wave guide 17.

In each of the three cases described above, it is that component of the electric field established between the electrodes which is parallel to the z-axis which is utilized for the electro-optical control.

FIG. 8 depicts a device 62 for doubling or multiplying light frequencies in which a crystal 63 is used which is cut in the x- or y-direction and in which an optical wave guide 64 extends in the y-direction of the yz-plane or in the x-direction in the xz-plane. Here, too, the wave guide 64 traverses a grid structure made up of first and second grid sections 65, 66. Each of these grid sections 65, 66 consist of inversion regions 67, 68 and normal regions 69, 70. In contrast to the previously described devices 15 and 38, the grid lines formed by the inversion and normal regions 67 and 70 do not extend in the x-direction but in the z-direction. In addition, the first and second grid section 65 and 66 form a grid region 71 here also, several of which are linearly arrayed. A pair of electrodes is associated with each of the second grid sections 66, one electrode 72 being comb-shaped and the second electrode 73 being strip-shaped. The comb-shaped electrode 72 is positioned on the upper surface of the crystal 63 such that its electrode fingers 74 extend in the z-direction along the inversion regions 68 and terminate at a distance from the wave guide 64. The strip-shaped electrode 73 is arranged at the opposite side of the wave guide 64, spaced therefrom and parallel thereto. Positioning of one electrode 72 at one side of the wave guide 64 and of the other electrode 73 at the other side of the wave guide 64 results, when applying a voltage to the electrodes 72, 73, in using the horizontal component of the generated electric field for changing the refractive index.

It has been possible with the devices 15, 38 and 62 described supra to accomplish a highly efficient duplication or multiplication of the frequency of light, especially of laser light.

1. A device for multiplying frequencies of light, especially of laser light, with an optically non-linear element provided with a grid structure with normal regions and inversion regions, the direction of the spontaneous polarization being inverted in the inversion regions relative to the normal direction in the normal regions, and with electrodes for establishing an electric field, characterized by the fact
that the grid structure is made up of at least a first grid section 21; 41; 65) and a second grid section (22; 42; 66) directly abutting the first grid section (21; 41; 65) and that the electrodes (29, 30; 51, 52; 54, 55; 58, 59, 60; 72, 73) are associated with the second grid section (22; 42; 66).

2. The device of claim 1, characterized by the fact
that the second grid section (22; 42; 66) has a grid period deviating from the grid period of the first grid section (21; 41; 65).

3. The device of claim 1 or 2, characterized by the fact
that at least a first and an abutting second grid section (21, 22; 41, 42; 65, 66) form a grid region (27; 47; 71) and that several grid sections (27; 47; 71) are provided.

4. The device of claim 3, characterized by the fact
that the grid periods of the first and/or second grid sections (41, 41′, 42, 42′) are different from grid region (47) to grid region (47′).

5. The device of one of claims 1 to 4, characterized by the fact
that the optically non-linear element is fabricated from a plate-shaped ferro-electric crystal (16; 39; 63).

6. The device of claim 5, characterized by the fact
that the crystal (16; 39; 63) consists of LiNbO₃ or LiTaO₃.

7. The device of claim 5 or 6, characterized by the fact
that the grid structure completely permeates the plate-shaped crystal (16; 39; 63) from its upper surface (20) to its lower surface (28).

8. The device of one of claims 5 to 7, characterized by the fact that
the grid structure extends from one front surface (18; 48) to the other front surface (19; 49) of the crystal (16, 39; 63).

9. The device of one of claims 5 to 8, characterized by the fact
that the crystal (16; 39; 63) is provided with an optical wave guide (17; 40; 64) which extends between two front surfaces (18, 19; 48, 49) of the plate-shaped crystal (16; 39; 63) along the upper surface (20) thereof and which traverses the grid sections (21, 22; 41, 42; 65, 66).

10. The device of claim 9, characterized by the fact
that the crystal is cut in the z-direction and that the wave guide (17; 40) extends in the y-direction in the xy-plane.

11. The device of claim 10, characterized by the fact
that a pair of comb-shaped electrodes (29, 30) is associated with every second grid section (22) whereby one of the electrodes (3) of the electrode pair is positioned on the upper surface (26) of the crystal (16) such that the electrode fingers (32) thereof extend in the x-direction along the normal regions (26) of the second grid section (22) and the other electrode (29) of the electrode pair is positioned on the upper surface (20) of the crystal (16) such that the electrode fingers (31) thereof extend in the x-direction along the inversion regions (24) of the second grid section (22), the length of the fingers (31, 32) of the two electrodes (29, 30) being such that they interdigitally extend over the width of the wave guide (17), the width of each of the electrode fingers (31, 32) of the two electrodes (29, 30) being structured narrower than the inversion and normal regions (24, 26) extend in the y-direction.

12. The device of claim 11, characterized by the fact
that each of the electrode fingers (31, 32) is positioned on the inversion and normal regions (24, 26) centrally in the direction of the grid lines.

13. The device of claim 10, characterized by the fact
that an electrode pair is associated with each of the second grid sections (22) and that one electrode (54) of the electrode pair is comb-shaped and positioned on the upper surface (20) of the crystal (16) such that the electrode fingers (56) thereof extend in the x-direction along the inversion regions (24) and cover the width of the wave guide (17) and that the second electrode (55) of the electrode pair is strip-shaped and is positioned on the upper surface (20) of the crystal (16) at a distance from the wave guide (17) and parallel thereto.

14. The device of claim 10, characterized by the fact
that an electrode pair is associated with each of the second grid sections (22) and that one electrode (54) of the electrode pair is comb-shaped and positioned on the upper surface (20) of the crystal (16) such that the electrode fingers (56) thereof extend in the x-direction along the inversion regions (24) and terminate at a distance from the wave guide (17) and that the second electrode of the electrode pair is strip-shaped and arranged on the upper surface (20) of the crystal (16) in longitudinal direction of the wave guide (17) and covering the same.

15. The device of claim 10, characterized by the fact
that two outer electrodes (58, 59) and a center electrode (57) are associated with each of the second grid sections (22) and the center electrode (57) is strip-shaped and is centrally arranged on the upper surface (20) of the crystal (16) to extend in the longitudinal direction of the wave guide (17) and covering the same and that the outer electrodes (58, 59) are comb-shaped and positioned on the upper surface (20) of the crystal (16) on both sides of the wave guide (17) such that the electrode fingers (60, 61) thereof extend in the x-direction along the inversion regions (24) and terminate at a distance from the wave guide (17).

16. The device of claim 9, characterized by the fact
that the crystal (63) is cut in the x-direction and that the wave guide (64) extends in the y-direction of the yz-plane or that the crystal (63) is cut in the y-direction and the wave guide (64) extends in the x-direction of the xz-plane.

17. The device of claim 16, characterized by the fact
that an electrode pair is associated with each of the second grid sections (66) and that one electrode (72) of the electrode pair is comb-shaped and is positioned on the upper surface of the crystal (63) such that the electrode fingers (74) thereof extend in the z-direction along the inversion regions (68) and terminate at a distance from the wave guide (64) and that the second electrode (73) of the electrode pair is strip-shaped and is arranged on the upper surface of the crystal (93) on the opposite side of the wave guide (64) at a distance therefrom and parallel thereto.

18. The device of one of claims 1 to 17, characterized by the fact
that the electrodes (29, 30; 51, 52; 54, 55; 58, 59, 60; 72, 73) consist of metal and that between the electrodes (29, 30; 51, 52; 54, 55; 58, 59, 60; 72, 73) and the crystal (16; 39; 63) there is provided an optically transparent insulation layer.

19. The device of one of claims 1 to 17, characterized by the fact
that the electrodes (29, 30; 51, 52; 54, 55; 58, 59, 60; 72, 73) consist of an optically transparent electrically conductive material.

20. The device of one of claims 1 to 19, characterized by the fact
that the electrodes (29, 30; 51, 52; 54, 55; 58, 59, 60; 72, 73) associated with the second grid sections (22; 42; 66) may be energized with different electrical voltages (V_{1, v, v}, . . . Vₙ.
